(19) United States
(12) Patent Application Publication
(10) Pub. No.: US 2015/0079838 A1
(43) Pub. Date: Mar. 19, 2015

(54) ELECTRICALLY CONNECTING CABLE

(71) Applicant: SilverStone Technology Co., Ltd., New Taipei City (TW)

(72) Inventor: Wei-Cheng HUNG, New Taipei City (TW)

(73) Assignee: SilverStone Technology Co., Ltd., New Taipei City (TW)

(21) Appl. No.: 14/026,193

(22) Filed: Sep. 13, 2013

(51) Int. Cl. H01R 25/00

(52) U.S. Cl. CPC H01R 25/003
USPC 439/502

(57) ABSTRACT

The present invention is related to an electrically connecting cable including two plug connector and a conductive wire. Each plug connector includes a main body and a plugging portion extending from the main body. The plugging portion is of a plate shape, and the plugging portion is compatible with a female SATA connector and applied to be plugged into the female SATA connector. The conductive wire is connected between two main bodies. At the joint between the main body and the conductive wire, a longitudinal direction of the conductive wire is parallel with the plugging portion, and the longitudinal direction is perpendicular with an extending direction of the plugging portion. Accordingly, when the electrically connecting cable of the present invention is connected on the motherboard, the electrically connecting cable would not interfere in other parts on the motherboard.

### BACKGROUND

1. Field of the Invention

The present invention is related to an electrically connecting cable, particularly an electrically connecting cable adapting for a narrow installation area.

2. Description of Related Art

SATA connecting cables are commonly used for connecting between a motherboard and a hard disk drive. A female connector is usually set on the motherboard, and a male connector corresponding to the female connector is plugged into the female connector, where the female connector is usually connected with the male connector in a direction perpendicular to the motherboard.

Current computers are more efficient than old ones. A module card (such as a graphic card) plugged on the motherboard generates more heat than an old one does, and a means of heat dissipation therefore have to be provided thereon. Female SATA connectors on the motherboard are usually interfered by big module cards plugged on the motherboard. Therefore, the female SATA connectors has difficulty to be plugged, and even cannot be plugged. An improved SATA connecting cable with an L type male connector has limited ability to avoid interference with module cards. Moreover, the L type male connector might interfere in adjacent female connectors.

### SUMMARY

The purpose of the present invention is to provide an electrically connecting cable adapting for a narrow installation area.

In order to make the purpose, an electrically connecting cable including two plug connectors and a conductive wire is provided in the present invention. Each plug connector includes a main body and a plugging portion extending from the main body. The plugging portion is of a plate shape, and the plugging portion is compatible with a female SATA connector and applied to be plugged into the female SATA connector. The cable is connected between two main bodies. At the joint between the main body and the conductive wire, a longitudinal direction of the conductive wire is parallel with the plugging portion, and the longitudinal direction is perpendicular with an extending direction of the plugging portion.

The electrically connecting cable is preferably including a plurality of conductive wires.

Each conductive wire is preferably of a belt shape, and the conductive wires are arranged in a stack.

Each conductive wire is preferably of a belt shape, and the conductive wires are arranged to be parallel with each other.

The plugging portions of each plug connector are preferably conformed to a specification of a male SATA connector.

A plurality of conductive terminals are preferably provided in each plug connector. Each conductive terminal is extending from the main body to the plugging portion. Each end of the conductive wire is inserted into the corresponding main body and connected to at least one of the conductive terminals in the main body.

A plugging socket is preferably defined at the edge of each plugging portion along the extending direction of the plugging portion. Each conductive terminal is exposed in the plugging socket.

A plurality of conductive lines are preferably included in each conductive wire. Each end of the conductive line is electrically connected to one of the terminals in the main body.

Each conductive wire is preferably of a belt shape, and the width of the conductive wire is longer than the thickness of the conductive wire. At the joint between the conductive wire and the main body, the width direction of the conductive wire is parallel with the extension direction of the plugging portion.

The thickness of the conductive wire is preferably equal to or less than 1 mm.

The diameter of the conductive wire is preferably equal to less than 1 mm.

The electrically connecting cable of the present invention could be bent and arranged to be parallel with the motherboard when connected on the motherboard. The electrically connecting cable of the present invention could be arranged in the gaps between adjacent plug connectors. Accordingly, when the electrically connecting cable of the present invention is connected on the motherboard, the electrically connecting cable would not interfere in other parts set on the motherboard.

### BRIEF DESCRIPTION OF DRAWING

FIG. 1 is a schematic view showing the first embodiment of the present invention;

FIG. 2 is a partial perspective view showing the first embodiment of the present invention;

FIG. 3 is a schematic view showing a using status of the present invention;

FIG. 4 is a schematic view showing another using status of the present invention;

FIG. 5 is a schematic view showing the second embodiment of the present invention.

### DETAILED DESCRIPTION OF EMBODIMENT

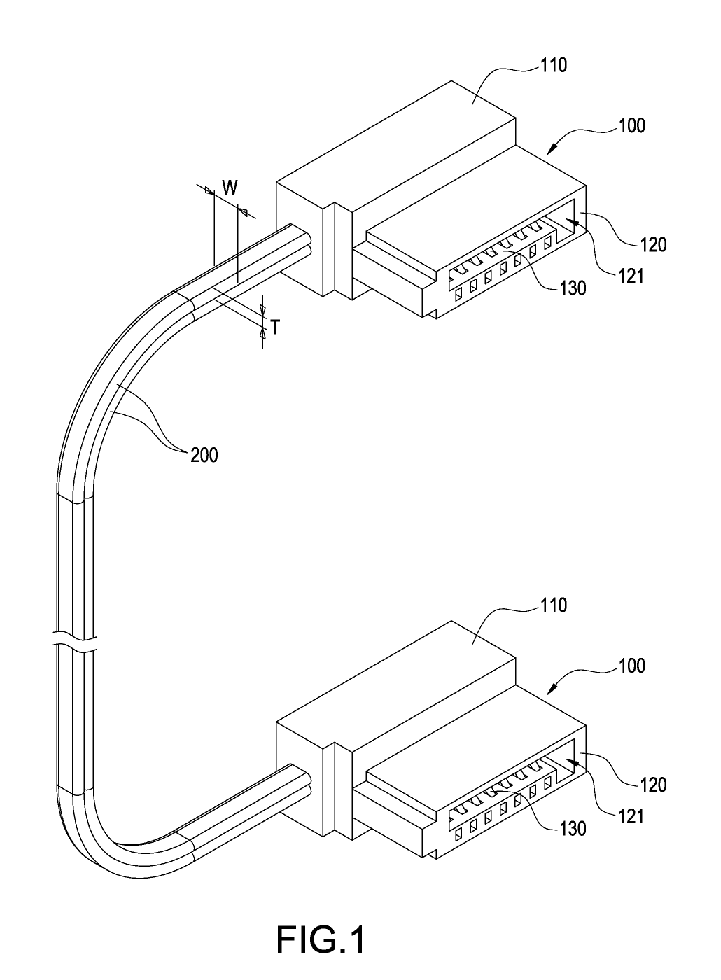

Please refer to FIG. 1. An electrically connecting cable is provided in the first embodiment of the present invention. The electrically connecting cable includes two plug connectors (100) and two conductive wires (200).

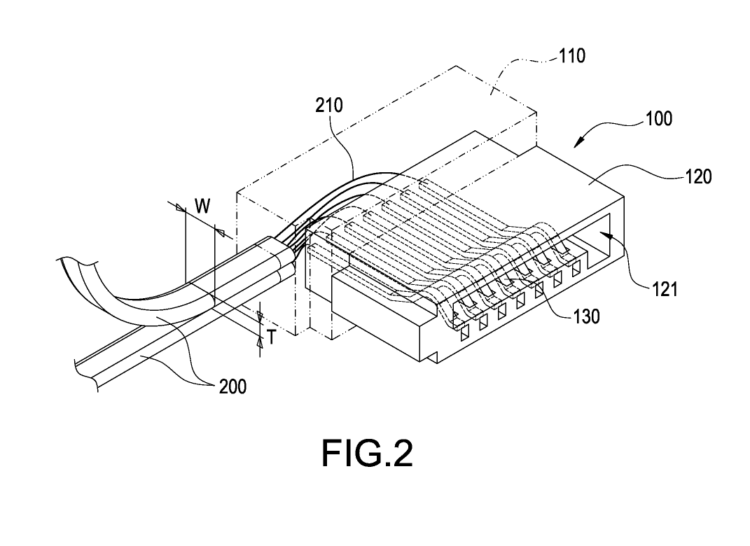

Please refer to FIGS. 1 and 2. Each plug connector (100) includes a main body (110) and a plugging portion (120) extending from the main body (110). A plurality of conductive terminals (130) parallel with each other are provided in each plug connect (100), and each terminal (130) extends from the main body (100) to the plugging portion (120). In the present embodiment, the plugging portion (120) is preferably of a plate shape, and the main body (110) is a block formed on the plugging portion (120) via insert molding. Nevertheless, insert molding is not a limitation of the present invention. In the present embodiment, a plugging socket (121) is defined at an edge of the plugging portion (120), and the plugging socket (121) is along the extension direction of the plugging portion (120). The plugging socket (121) is preferably of an L shape, and each conductive terminal (130) is exposed in the plugging socket (121). Accordingly, each plugging portion (120) is conformed to a male SATA connector and compatible with a female SATA connector.

Each conductive wire (200) is connected between two main bodies (110), and each conductive wire (200) is of a plate shape. The width (W) of the conductive wire (200) is longer than the thickness (T) of the conductive wire (200), and the thickness (T) of the conductive wire (200) is equal to or less than 1 mm. In the present embodiment, the width (W) of the conductive wire (200) is preferably 2.1 mm, and the thickness (T) of the conductive wire (200) is preferably 0.9 mm. Nevertheless, the specific size of the conductive wire (200) is not a limitation of the present invention. For example, the conductive wire (200) could be a cylindrical wire, and the diameter of the conductive wire (200) is equal to or less than 1 mm. At the joint between the main body (110) and the conductive wire (200), the width (W) direction of the conductive wire (200) is perpendicular with the extension direction of the plugging portion (120), and a longitudinal direction of the conductive wire (200) is parallel with the plugging portion (120). Each end of each conductive wire (200) is inserted in to the corresponding main body (110), and connected to at least one of the conductive terminal (130) in the main body (110). Nevertheless, the connection way between the conductive wire (200) and the terminal (130) is not a limitation of the present invention.

The two conductive wires (200) are arranged to be parallel with each other. In the present invention, the conductive wires (200) are arranged in a stack in the thickness (T) direction thereof, but this is not a limitation of the present invention. For example, the two conductive wires (200) could be arranged to be parallel with each other in the width (W) direction thereof

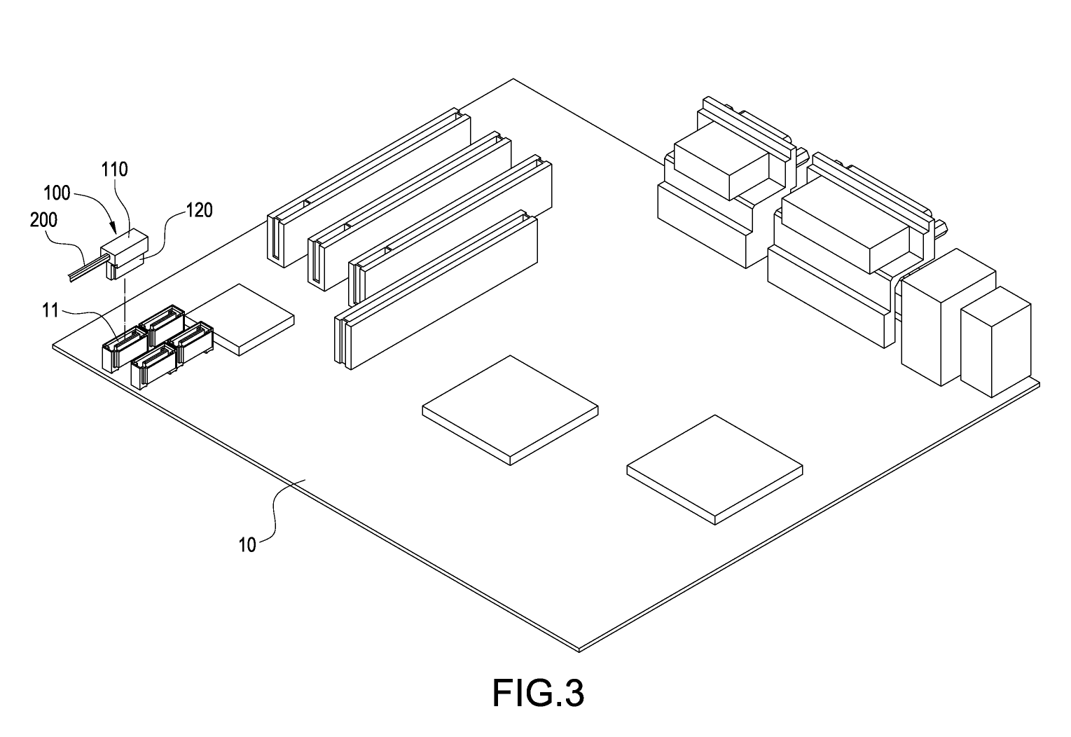

Please refer to FIG. 3. The electrically connecting cable is used for electrically connecting a motherboard (10). A plurality of female SATA connectors (11) are provided on the motherboard (10). Any of the plug connector (100) is applied to be plugged into one of the female SATA connectors (11).

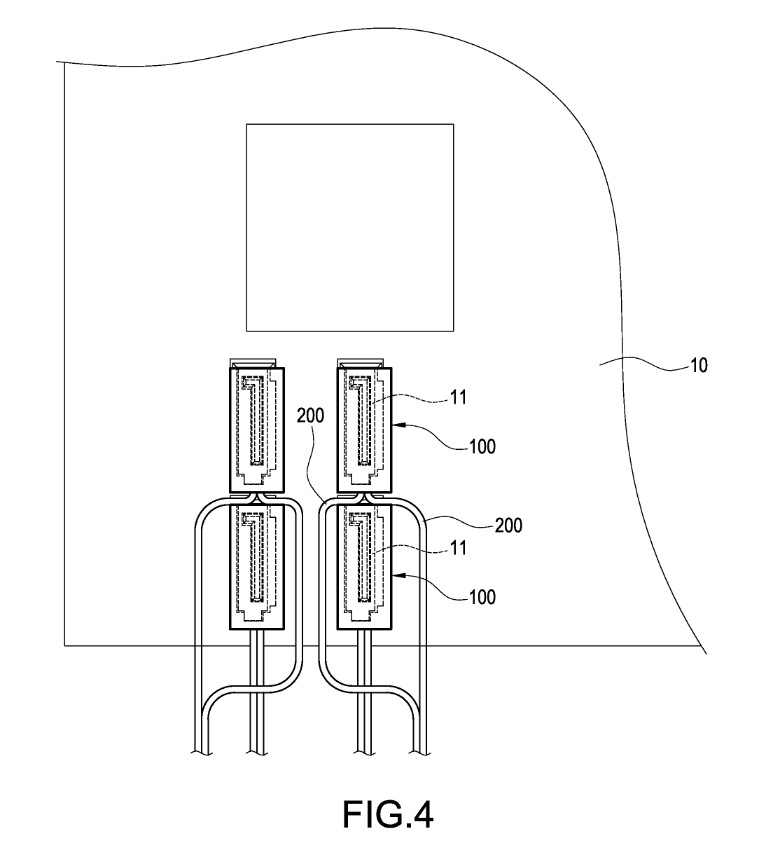

Please refer to FIG. 4. When multiple electrically connecting cables are plugged in the female SATA connectors (11), one of the plug connectors (100) plugged in a female SATA connectors (11) is adjacent with another plug connector (100) plugged in another adjacent female SATA connector (11). The conductive wires (200) could be bent and arranged to be parallel with the motherboard (10), and thereby could be arranged in the gaps between adjacent plug connectors. Accordingly, when the electrically connecting cable of the present invention is connected on the motherboard (10), the electrically connecting cable can be prevented from interfering in other parts on the motherboard (10). Therefore, the space on the motherboard (10) could be used more efficiently.

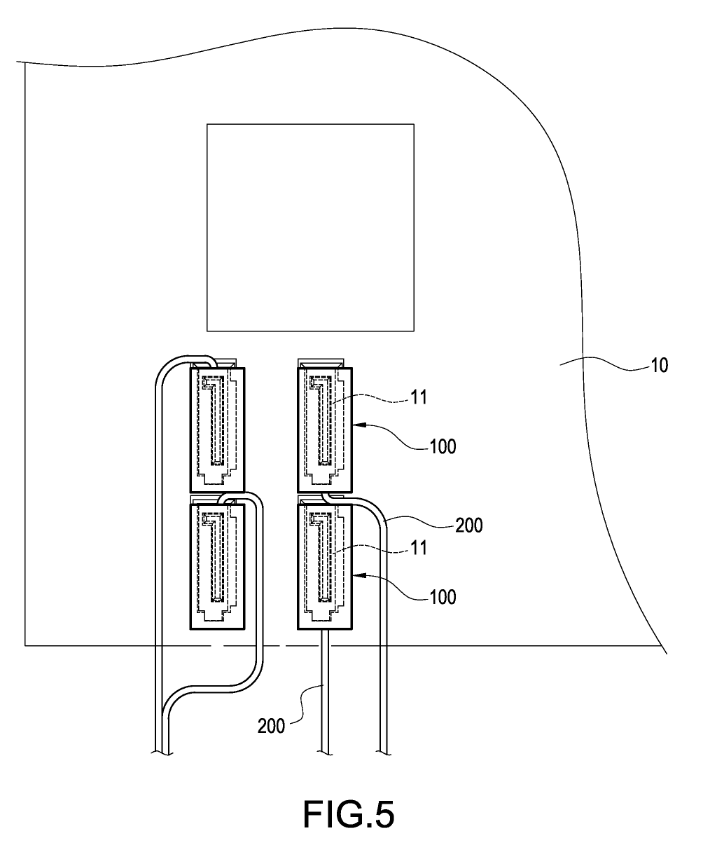

Please refer to FIG. 5. An electrically connecting cable is provided in the second embodiment of the present inventions. The electrically connecting cable of the present embodiment is similar to the first embodiment. The components in this embodiment, which are the same as those in the first embodiment will not be mentioned bellow for brevity. In the present embodiment, the electrically connecting cable includes just one conductive wire (200), and the location of the joint between the conductive wire (200) and the plug connector (100) is not limited.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An electrically connecting cable comprising:
two plug connectors (100), each plug connector comprising a main body (110) and a plugging portion (120) extending from the main body(110), the plugging portion (120) being of a plate shape, the plugging portion (120) compatible with a female SATA connector, and the plugging portion (120) being pluggable into the female SATA connector; and
a conductive wire (200) connected between two main bodies (110), a longitudinal direction of the conductive wire (200) being parallel with the plugging portion (120) at the joint between the main body (110) and the conductive wire (200), and a longitudinal direction of the conductive wire (200) being perpendicular with an extending direction of the plugging portion (120).

2. The electrically connecting cable according to claim 1, wherein the electrically connecting cable is comprised of a plurality of conductive wires (200).

3. The electrically connecting cable according to claim 2, wherein each conductive wire (200) is of a belt shape, and the conductive wires (200) are arranged in a stack.

4. The electrically connecting cable according to claim 2, wherein each conductive wire (200) is of a belt shape, and the conductive wires (200) are arranged to be parallel with each other.

5. The electrically connecting cable according to claim 1, wherein the plugging portions (120) of each plug connector (100) are conformed to a specification of a male SATA connector.

6. The electrically connecting cable according to claim 1, wherein a plurality of conductive terminals (130) are provided in each plug connector (100), each conductive terminal (130) is extending from the main body (110) to the plugging portion (120), and each end of each conductive wire (200) is inserted into the corresponding main body (110) and connected to at least one of the conductive terminals (130) in the main body (110).

7. The electrically connecting cable according to claim 6, wherein a plugging socket (121) is defined at an edge of each plugging portion (120) along the extending direction of the plugging portion (120), and each conductive terminal (130) is exposed in the plugging socket (121).

8. The electrically connecting cable according to claim 6, wherein a plurality of conductive lines (210) are provided in each conductive wire (200), and each end of the conductive line (210) is electrically connected to one of the terminals (130) in the main body (110).

9. The electrically connecting cable according to claim 1, wherein each conductive wire (200) is of a belt shape, the width (W) of the conductive wire (200) is longer than the thickness (T) of the conductive wire (200), and a width direction of the conductive wire (200) is parallel with an extension direction of the plugging portion (120) at a joint between the conductive wire (200) and the main body (110).

10. The electrically connecting cable according to claim 9, wherein the thickness (T) of the conductive wire (200) is equal to or less than 1 mm.

11. The electrically connecting cable according to claim 1, wherein the diameter of the conductive wire (200) is equal to or less than 1 mm.
